(19) United States
(12) Patent Application Publication
(10) Pub. No.: US 2026/0310153 A1
(43) Pub. Date: Oct. 8, 2026

(54) COMPUTER-IMPLEMENTED METHOD FOR MANAGING A PLURALITY OF ASSETS OF A VIRTUAL POWER PLANT

(71) Applicant: ELISA OYJ, Helsinki (FI)

(72) Inventors: Jukka-Pekka SALMENKAITA, Helsinki (FI); Simon HOLMBACKA, Helsinki (FI); Esko HEINONEN, Helsinki (FI)

(73) Assignee: ELISA OYJ, Helsinki (FI)

(21) Appl. No.: 19/481,378

(22) PCT Filed: May 2, 2024
(86) PCT No.: PCT/FI2024/050207

§ 371 Date: Nov. 4, 2025

(30) Foreign Application Priority Data
May 4, 2023 (FI) 20235497

(51) Int. Cl. G05B 19/042

(52) U.S. Cl. CPC G05B 19/042; G05B 2219/2639

(57) ABSTRACT

According to an embodiment, a computer-implemented method for managing a plurality of assets of a virtual power plant, wherein each asset in the plurality of assets comprises at least one battery unit, comprises: assigning the plurality of assets into 2024/227976 a plurality of groups, wherein the plurality of groups comprises at least a reserve group and at least one active group and each asset in the plurality of assets is assigned to one group in the plurality of groups; in response to receiving an activation signal for power grid frequency balancing, offering assets for the power grid frequency balancing from groups in the plurality of groups other than the reserve group; and in response to detecting a need for state of charge adjustment in the virtual power plant, performing the state of charge adjustment using the reserve group.

WO

### TECHNICAL FIELD

The present disclosure relates to distributed energy storage systems, and more particularly to a computer-implemented method for managing a plurality of assets of a virtual power plant, a computing device, a virtual power plant, and a computer program product.

### BACKGROUND

A virtual power plant can comprise a large number of assets with battery units. When working in national frequency reserve markets, the market operator can require each participant to deliver a selected amount of frequency balancing capacity for the market during the time of resource activation. The activated frequency balancing capacity is usually not allowed to fluctuate significantly from its intended setpoint, and sanctions against the participants can be put in case the participant is not able to deliver steady capacity for the market.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide a computer-implemented method for managing a plurality of assets of a virtual power plant, a computing device, a virtual power plant, and a computer program product. The fore-going and other objectives are achieved by the features of the independent claims. Further implementation forms are apparent from the dependent claims, the description and the figures.

According to a first aspect, a computer-implemented method for managing a plurality of assets of a virtual power plant, wherein each asset in the plurality of assets comprises at least one battery unit, comprises: assigning the plurality of assets into a plurality of groups, wherein the plurality of groups comprises at least a reserve group and at least one active group and each asset in the plurality of assets is assigned to one group in the plurality of groups; in response to receiving an activation signal for power grid frequency balancing, offering assets for the power grid frequency balancing from groups in the plurality of groups other than the reserve group; and in response to detecting a need for state of charge adjustment in the virtual power plant, performing the state of charge adjustment using the reserve group. The method can, for example, enable the at least one active group to be used for frequency balancing while state of charge adjustments can be implemented using the reserve group.

In an implementation form of the first aspect, the method further comprises, in response to detecting a need for reassigning at least one asset in the plurality of assets, reassigning the at least one asset into the plurality of groups. The method can, for example, enable changing the assignment of the plurality of assets into the plurality of groups.

In another implementation form of the first aspect, the need for reassigning the at least one asset in the plurality of assets corresponds a change in a power grid market time slot. The method can, for example, enable changing the assignment of the plurality of assets into the plurality of groups during changes in the power grid market time slot.

In another implementation form of the first aspect, the need for reassigning the at least one asset in the plurality of assets comprises needing to reassign at least one problematic asset in the at least one active group and the reassigning the at least one asset in the plurality of assets into the plurality of groups comprises reassign the at least one problematic asset to the reserve group. The method can, for example, enable changing the assignment of the at least one problematic asset when needed.

In another implementation form of the first aspect, the needing to reassign the at least one problematic asset in the at least one active group comprises an operating parameter of the at least one problematic asset in the at least one active group being outside a preconfigured operating parameter range. The method can, for example, enable changing the assignment of the at least one problematic asset when an operating parameter of the at least one problematic asset is outside a pre-configured operating parameter range.

In another implementation form of the first aspect, the operating parameter comprises a state of charge, an operating temperature, and/or a battery state of health. The method can, for example, enable changing the assignment of the at least one problematic asset when a state of charge, an operating temperature and/or a battery state of health of the at least one problematic asset is outside a preconfigured operating parameter range.

In another implementation form of the first aspect, the reassigning the at least one asset in the plurality of assets into the plurality of groups further comprises assigning at least one replacement asset for the at least one problematic asset from the reserve group to the at least one active group. The method can, for example, enable maintaining regulation capacity of the at least one active group.

In another implementation form of the first aspect, the assigning the plurality of assets into the plurality of groups comprises assigning the plurality of assets into the plurality of groups for each time slot in a plurality of power grid market times slots. The method can, for example, enable assigning the plurality of assets into the plurality of groups according to, for example, predicted requirements of each time slot.

In another implementation form of the first aspect, the assigning the plurality of assets into the plurality of groups comprises assigning the plurality of assets into the plurality of groups based at least on a likelihood of each asset in the plurality of assets needing state of charge adjustment during a time period when the plurality of assets is used for the power grid frequency balancing. The method can, for example, enable assigning the plurality of assets into the plurality of groups according to likelihood of each asset in the plurality of assets needing state of charge adjustment.

In another implementation form of the first aspect, the assigning the plurality of assets into the plurality of groups further comprises: determining a required state of charge adjustment capacity for the virtual power plant; and assigning the plurality of as-sets into the plurality of groups based at least on the required state of charge adjustment capacity. The method can, for example, enable assigning the plurality of as-sets into the plurality of groups according to the re-quired state of charge adjustment capacity.

In another implementation form of the first aspect, the at least one active group comprises a plurality of active groups and each active group in the plurality of active groups corresponds to a use case in a plurality of use cases. The method can, for example, enable assigning the plurality of assets into the plurality of groups according to the plurality of use cases.

According to a second aspect, a computing device comprises at least one processor and at least one memory including computer program code, the at least one memory and the computer program code being configured to, with the at least one processor, cause the computing device to perform the method according to the first aspect.

According to a third aspect, a virtual power plant comprises the computing device according the second aspect and a plurality of assets coupled to a power grid, wherein each asset in the plurality of assets comprises at least one battery unit.

According to a fourth aspect, a computer program product comprises program code configured to perform the method according to the first aspect when the computer program product is executed on a computer.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 illustrates a flow chart representation of a method according to an embodiment;

FIG. 2 illustrates a schematic representation of virtual power plant assets according to an embodiment;

FIG. 3 illustrates a schematic representation of virtual power plant assets according to another embodiment;

FIG. 4 illustrates a schematic representation of problematic asset rotation according to an embodiment;

FIG. 5 illustrates a schematic representation of an asset according to an embodiment;

FIG. 6 illustrates a schematic representation of a computing device according to an embodiment; and

FIG. 7 illustrates a schematic representation of a virtual power plant according to an embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

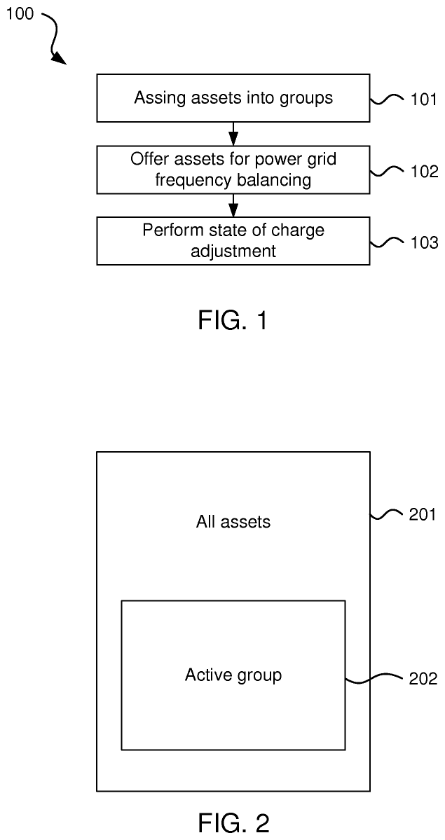

FIG. 1 illustrates a flow chart representation of a method according to an embodiment.

According to an embodiment, a computer-implemented method 100 for managing a plurality of assets of a virtual power plant, wherein each asset in the plurality of assets comprises at least one battery unit, comprises assigning 101 the plurality of assets into a plurality of groups, wherein the plurality of groups comprises at least a reserve group and at least one active group and each asset in the plurality of assets is assigned to one group in the plurality of groups.

Herein, an asset may also be referred to as a physical asset, a node, a unit, a distributed energy resource, a site, a battery site, or similar.

Herein, a virtual power plant (VPP) may refer to a distributed power plant comprising a plurality of assets. A VPP can aggregate the capacities of the plurality of assets.

Herein, a group may also be referred to as an asset group, a category, an asset category, or similar.

The plurality of groups may comprise any number of groups in addition to the reserve group and the at least one active group. Further, the at least one active group may comprise any number of active groups.

The method 100 may further comprise, in response to receiving an activation signal for power grid frequency balancing, offering 102 assets for the power grid frequency balancing from groups in the plurality of groups other than the reserve group.

For example, the offering 102 assets for the power grid frequency balancing from groups in the plurality of groups other than the reserve group may comprise offering assets for the power grid frequency balancing from the at least one active group.

Frequency balancing of a power grid may be arranged for example using automatic Frequency Restoration Reserve (aFRR) capacity market. aFRR is a centralized automatically activated reserve. Its activation is based on a power change signal calculated on the base of the frequency deviation in the Nordic synchronized area. Its purpose is to return the frequency of the power grid to the nominal value.

Frequency balancing of electric grid may also be arranged using, for example, Frequency Containment Reserve for Normal Operation (FCR-N) or Frequency Containment Reserve for Disturbances (FCR-D) that are active power reserves that are automatically controlled based on the frequency deviation. Their purpose is to contain the frequency during normal operation and disturbances. FCR is an active power reserve that is automatically controlled based on the frequency deviation. FCR may be Frequency Containment Reserve for Normal Operation, FCR-N, or Frequency Containment Reserve for Disturbances, FCR-D. Their purpose is to contain the frequency during normal operation and disturbances.

Various embodiments of the present disclosure can provide a centralized coordinator for managing a virtual power plant so that the asset owners are able to participate in frequency balancing of the power grid in, for example, the aFRR and/or FCR capacity market.

The frequency balancing may comprise up regulation and/or down regulation. Up regulation can comprise increasing power production and/or decreasing power consumption. Down regulation can comprise decreasing power production and/or increasing power consumption.

The activation signal may be provided by, for example, a grid operator. When working in national frequency reserve markets, the grid operator can require each participant to deliver a selected amount of frequency balancing capacity for the market during the time of resource activation. The activated frequency balancing capacity is usually not allowed to fluctuate significantly from its intended setpoint, and the participants can be sanctioned in case the participant is not able to deliver steady frequency balancing capacity for the market.

Herein, frequency balancing capacity may refer to the amount of power that can be offered/allocated for power grid frequency balancing by the VPP. Frequency balancing capacity may also be referred to as capacity, aggregated capacity, regulation capacity, or similar.

Herein, offering 102 assets for the power grid frequency balancing from groups in the plurality of groups other than the reserve group may comprise configuring the groups in the plurality of groups other than the reserve group to be used for the power grid frequency balancing. For example, when an asset is activated for the power grid frequency balancing, the asset can be configured to, for example, in the case of up regulation, feed power to the power grid from the at least one battery unit of the asset or to, in the case of down regulation, charge the at least one battery unit of the asset using power from the power grid.

The method 100 may further comprise, in response to detecting a need for state of charge adjustment in the virtual power plant, performing 103 the state of charge adjustment using the reserve group.

The detecting a need for state of charge adjustment in the VPP can comprise, for example, one or more of the plurality of assets reaching a state of charge (SOC) limit, such as the SOC being too high or too low. When the SOC of an asset is too high or too low, the asset cannot be used for frequency regulation effectively.

In some embodiments, the method 100 may comprise, in response to detecting a need for state of charge adjustment in the virtual power plant, performing the state of charge adjustment using the reserve group and not using the at least one active group.

The method 100 can, for example, enable offering a large portion of VPP assets towards market actions as one planned entity using the active group while enabling individual asset SOC adjustments using the reserve group.

In some embodiments disclosed herein, some functionality may be disclosed in terms of a three-layer VPP architecture. This architecture is only a non-limiting example and the functionality disclosed herein may also implemented in various other ways and/or using various other architectures.

A first control layer of the three-layer VPP architecture may be referred to as a planner and may be configured to determine in advance an operating plan for the DES system for a plurality of time slots of a first time period based on aggregated properties of the DES system, wherein the operating plan comprises allocation of aggregated capacity of the DES system for the plurality of time slots, and convey the operating plan to a second control layer.

The second control layer of the three-layer VPP architecture may be referred to as a supervisor and may be configured to determine rules for selecting assets of the DES system for obtaining the allocated aggregated capacity of the operating plan, monitor operation of the DES system in real time and responsively adjust the rules; and convey the rules to the third control layer.

A third control layer of the three-layer VPP architecture may be referred to as a controller and can be configured to execute selection and activation of individual assets of the VPP system in accordance with the rules.

FIG. 2 illustrates a schematic representation of virtual power plant assets according to an embodiment.

Distributed energy storage (DES) systems and other virtual power plant solution can control thousands of assets in the plurality of assets 201 at different sites.

When an asset, such as a mobile base station site with batteries, rectifiers and energy consumption associated with radio equipment, is part of actively managed capacity of a virtual power plant, it typically cannot adjust its charging/discharging behaviour without that change being directly reflected on the activated regulation capacity offered towards a transmission system operator (ISO).

For a large virtual power plant, it can be advantageous to be able to offer its full, or close to full, aggregated capacity towards market actions as a one planned entity in the active group 202. However, this may prevent SOC adjustments of individual assets, such as ad hoc changes to charging/discharging. This, in turn, can result in some or many assets reaching to SOC limits (low or high) and not being able to provide any more frequency balancing capacity.

Therefore, it can be advantageous to plan in advance, such as at aggregate level for the whole VPP, how much ad hoc adjustment capacity should be available during a day and be able to manage the individual assets in a way that allows ad hoc adjustments to them at some time periods during the day. Thus, it can be advantageous to have “extra unallocated” assets to fill in roles when needed.

The method 100 can address ways to implement a VPP system with multiple asset groups.

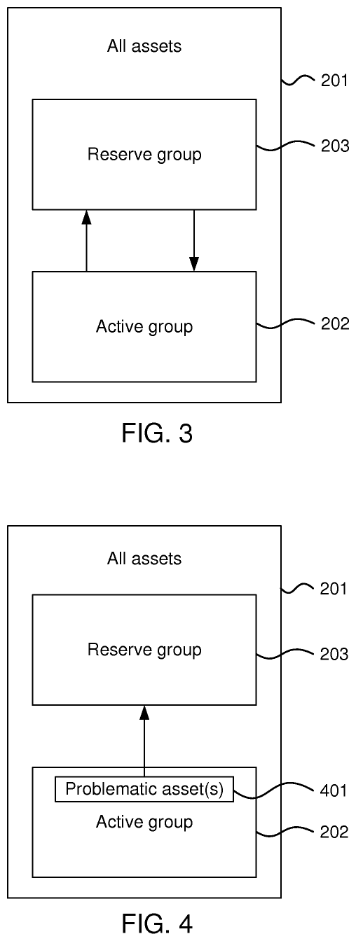

FIG. 3 illustrates a schematic representation of virtual power plant assets according to another embodiment.

A VPP system can comprise at least two groups for managed assets. One of the groups can comprise a reserve group 203 and at least one of the groups can comprise an active group 202. In some embodiments, the at least one active group 202 can comprise a plurality of active groups. The plurality of active groups can be used to, for example, optimize between different reserve markets and/or other use cases.

According to an embodiment, the at least one active group 202 comprises a plurality of active groups and each active group in the plurality of active groups corresponds to a use case in a plurality of use cases.

In some embodiments, the plurality of use cases may comprise an up-regulation use case and a down-regulation use case.

In some embodiments, the plurality of active groups comprises at least one active group corresponding to up regulation and at least one active group corresponding to down regulation.

Each use case in the plurality of use cases may correspond to, for example, a reserve market in a plurality of reserve markets.

In some embodiments, an asset can also be reassigned from a first use case in the plurality of use cases into a second use case in the plurality of use cases. This can be performed, for example, in response to detecting a need to reassign an asset from a first use case in the plurality of use cases into a second use case in the plurality of use cases. For example, an asset with high SOC can be rotated out from an aFRR down regulation use case and into an FFR use case for up regulation only.

Each asset may belong to one group at for each point of time.

Assets in the reserve group 203 may not be reported to TSO and/or similar reserve/balance market stakeholder as a part of the actively managed/available capacity.

The VPP system may initiate an ad hoc charging/discharging action for units assigned to the reserve group 203.

According to an embodiment, the assigning the plurality of assets into the plurality of groups comprises assigning the plurality of assets into the plurality of groups for each time slot in a plurality of power grid market times slots.

The power grid market times slots may also be referred to as time slots, market time slots, reserve market time slots, balance market time slots, or similar.

For example, the supervisor can allocate individual assets to the reserve and active groups for each timeslot, such as each hour, each 15 min slot, or similar. This, one component of the VPP can decide which asset should be in which group during the day.

At planning time, such as during the previous day before a market day, the planner component can allocate some part of aggregate VPP assets to the reserve group 203 and some to the active group 202 for each time slot. This can be done using, for example, optimization, machine learning logic, or based on expert setting. The allocation may not be necessarily constant. For example, less assets assigned to the reserve group during an early part of the day and more towards the end of the day can be a typical allocation. During the early parts of the day, there may be less need for the reserve group as this is closer to the planning time. As time goes on, there can be more unexpected events and thus there may be more need to utilize the reserve group during later parts of the day.

Further, individual assets may be transferred between groups. This can be done at, for example, time periods corresponding to changes in market time slots, such as every hour, every fifteen minutes etc.

According to an embodiment, the assigning the plurality of assets into the plurality of groups comprises assigning the plurality of assets into the plurality of groups based at least on a likelihood of each asset in the plurality of assets needing state of charge adjustment during a time period when the plurality of assets is used for the power grid frequency balancing.

For example, the supervisor can prioritize as-sets that have a high likelihood of requiring/benefiting from ad hoc SOC level adjustments when selecting assets to reserve category. This can comprise, for example, assets that are close to the top or bottom of an allowed SoC range. Vice versa, assets that have a low likelihood of requiring/benefiting from ad hoc Soc level adjustments can be assigned to the active category.

The supervisor can also handle market rule-based restrictions. For example, if an asset that has been serving balance markets should not use balance energy for x mins or x hours afterwards, then this asset should be assigned to the reserve group 203 for at least a time period of length x+y.

Since assets performing load-shifting purposes may not have the same market rule restrictions, the supervisor may also combine reserve/active category allocations with assigning some assets to only perform load-shifting purposes.

According to an embodiment, the assigning the plurality of assets into the plurality of groups further comprises: determining a required state of charge adjustment capacity for the virtual power plant; and assigning the plurality of assets into the plurality of groups based at least on the required state of charge adjustment capacity.

The required SOC adjustment capacity can be determined using various methods, such as reinforcement learning, traditional optimization, different heuristics etc. For example, the planner component can determine how much and at what time SOC adjustment capacity is required. The required SOC adjustment capacity can depend both on the plan structure and on market conditions. Load-shifting planning and SOC adjustment capacity planning may be co-optimized since load-shifting can be ad hoc adjusted without penalties from the TSO.

SOC adjustment capacity may also be referred to as reserve capacity.

If the aggregate SOC gets either too high or too low, it may be beneficial to perform actions in order to make the SOC return on a reasonable level. In some embodiments, this may be achieved by performing load-shifting on the assets in the at least one active group. Alternatively or additionally, some assets with SOC levels far from a target SOC level can be reassigned from the at least one active group to the reserve group and “fresh” assets having SOC levels closer to the target Soc level can be reassigned from the reserve group to the at least one active group.

In some embodiments, the planner may provide target levels, for example with price/cost guidance, and the supervisor can activate units to match the target levels. Thus, the adjustment can be set into a preferred range if actual expected cost of the adjustment is less than price/cost guidance. Thus, the supervisor component can determine how much, and by which units, unless this is done at controller level, balancing the assets in the reserve group 203 should do.

FIG. 4 illustrates a schematic representation of problematic asset rotation according to an embodiment.

According to an embodiment, the method further comprises, in response to detecting a need for reassigning at least one asset in the plurality of assets, reassigning the at least one asset into the plurality of groups.

The reassigning of an asset from one group in the plurality of groups to another group in the plurality of groups may also be referred to as a rotation of the asset.

According to an embodiment, the need for reassigning the at least one asset in the plurality of assets corresponds a change in a power grid market time slot.

For example, the reassigning the at least one asset into the plurality of groups may be performed during the change in the power grid market time slot so that the assignment can be different for different time slots.

According to an embodiment, the need for reassigning the at least one asset in the plurality of assets comprises needing to reassign at least one problematic asset 401 in the at least one active group 202 and the reassigning the at least one asset in the plurality of assets into the plurality of groups comprises reassign the at least one problematic asset 401 to the reserve group 203.

According to an embodiment, the needing to reassign the at least one problematic asset 401 in the at least one active group 202 comprises: an operating parameter of the at least one problematic asset 401 in the at least one active group 202 being outside a pre-configured operating parameter range.

For example, an administrator of the VPP can define preconfigured operating parameter ranges for various operating parameters of the assets.

According to an embodiment, the operating parameter comprises a state of charge, an operating temperature, and/or a battery state of health.

Additionally or alternatively, the operating parameter may comprise a battery voltage, a rectifier voltage, and/or a battery charging current.

Battery operated assets can require charging and discharging actions of the batteries to deliver up and down regulation to the market. A problem can occur when, for example, the battery is not able to charge or discharge fully according to its specification. For example, once the battery voltage drops beyond a certain limit, the battery may not be able to deliver enough current to drive the system load of the asset and the power source of the asset may need to be activated to assist the battery. This can in turn affect the frequency balancing capacity of the asset. In the same fashion, the charging current can be limited when, for example, batteries are almost full, the ambient temperature is too high/low, and/or other factors limit the charging of the batteries. It may be beneficial to reassign such problematic assets 401 to the reserve group 203.

In some embodiments, a problematic asset 401 in the at least one active group 202 can be reassigned based on a likelihood of the problematic asset 401 re-quiring SOC adjustments. For example, if the SOC of an asset is very high/low compared to a desired SOC, the asset may be considered problematic and reassigned to the reserve group 203.

For example, a planner component can indicate a targeted average SOC levels for different hours of the day. For example, a high SOC can be desired at certain hours but problematic at different hours.

In some embodiments, a problematic asset 401 in the at least one active group 202 can be reassigned based on a capability to effectively utilize reserve allocation. For example, an asset that is able to charge/discharge at high power level compared to the energy capacity is more capable of adjustments in short periods of time.

For example, in the embodiment of FIG. 4, a problematic asset 401 is reassigned from the active group 202 to the reserve group 203. For example, a supervisor can rotate out the problematic asset 401 because SOC of the problematic asset 401 is too low.

According to an embodiment, the reassigning the at least one asset in the plurality of assets into the plurality of groups further comprises assigning at least one replacement asset for the at least one problematic asset 401 from the reserve group 203 to the at least one active group 202.

Assets from the reserve group 203 can be rotated to replace at least one problematic asset 401 in the active group 202. For example, if the SOC of an asset in the active group 202 is very low, the asset can be rotated out and replaced with one or more assets from the reserve group 203. In some cases, one problematic asset 401 may need to be replaced with a plurality of replacement assets if, for example, the problematic asset 401 comprises a large frequency balancing capacity. For example, if a problematic asset consumes 10kW during down regulation, the problematic assets can be replaced with another 10kw asset or with two 5kw assets.

The at least one problematic asset 401 can be rotated out of the active group 202 so that the at least one problematic asset can start to rest. Resting can comprise, for example, charging the at least one battery unit of the at least one problematic asset 401, discharging the at least one battery unit of the at least one problematic asset 401, cooling the temperature of some components of the at least one problematic asset 401, or performing any other actions in order to bring operating parameters of the at least one problematic asset 401 closer to a nominal state.

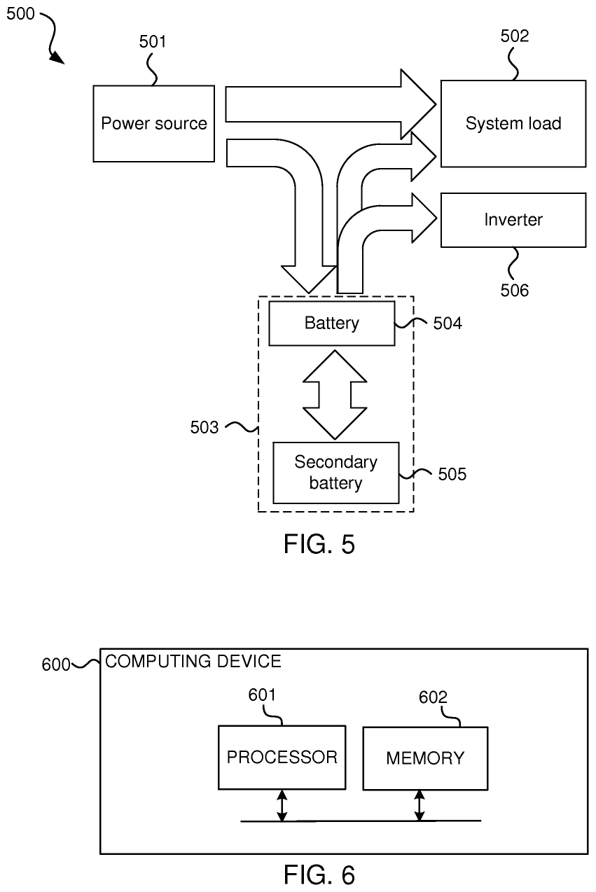

FIG. 5 illustrates a schematic representation of an asset according to an embodiment.

Each asset 500 can comprise at least one power source 501. The power source 501 can be, for example, electrically coupled to the power grid. Alternatively or additionally, the power source 501 may comprise some other type of power source, such as at least one renewable energy power source. For example, the power source 501 may comprise at least one solar panel, at least one wind turbine, and/or similar.

According to an embodiment, each asset 500 in the plurality of assets comprises a rectifier for charging the at least one battery unit 503 using power from the power grid and/or each asset 500 in the plurality of assets comprises an inverter 506 for feeding power to the power grid from the at least one battery unit 503.

For example, if the asset 500 comprises a direct current (DC) system, such as in the embodiment of FIG. 5, the at least one power source 501 can comprise at least one rectifier for converting the alternating current (AC) to DC compatible with the asset 500. For example, the at least one rectifier can convert 230-volt AC to 48-volt DC. The at least one power source 501 can be used to drive a system load 502. The at least one power source 501 can also be used to provide power to the at least one battery unit 503.

In other embodiments, the at least one battery unit 503 may comprise alternatively or additionally, for example, a capacitor, a supercapacitor, and/or similar.

For example, in the embodiment of FIG. 5, the at least one battery unit 503 comprises a main battery 504 and a secondary battery 505. The secondary battery 505 can comprise, for example, a battery of an electric vehicle. The secondary battery 505 can be connected, for example, in parallel with the main battery 504 for bi-directional charging. When the secondary battery 505 is connected, it can provide additional current to the asset 500 on demand to meet the system load 502 or inverter 506 requirements.

The rectifier can be “partly” used if the terminal voltage of the rectifier is set slightly lower than the battery voltage. In such a configuration, some current is drawn to the system load 502 from the rectifier and some from the at least one battery unit 503.

The at least one battery unit 503 can be used to drive the system load 502 when being controlled to, and to receive charge from the power source 501 during recharge periods. The current from/to the at least one battery unit 503 is not always its theoretical maximum due to various factors, such as those disclosed herein.

The system load 502 can comprise, for example, various equipment consuming power, the type of the equipment can be essentially anything consuming electricity. If the power source 501 is partly pushing current to the system load 502, the frequency balancing capacity for up regulation of the asset 500 may not be equal to its power consumption but less.

For example, the asset 500 may be embodied in a base station of a telecommunication network. The system load 502 may comprise equipment of the base station. The at least one battery unit 503 can be used for power redundancy of the base station in addition to power grid frequency balancing.

The asset 500 can further comprise at least one inverter 506 that can be electrically coupled to the at least one battery unit 503 and to the power grid. The at least one inverter 506 can be used to push electricity back to the power grid from the at least one battery unit 503.

FIG. 6 illustrates a schematic representation of a computing device according to an embodiment.

According to an embodiment, a computing device 600 comprises at least one processor 601 and at least one memory 602 including computer program code, the at least one memory 602 and the computer program code configured to, with the at least one processor 601, cause the computing device 600 to perform the method 100.

The computing device 600 may comprise at least one processor 601. The at least one processor 601 may comprise, for example, one or more of various processing devices, such as a co-processor, a microprocessor, a digital signal processor (DSP), a processing circuitry with or without an accompanying DSP, or various other processing devices including integrated circuits such as, for example, an application specific integrated circuit (ASIC), a field programmable gate array (FPGA), a microprocessor unit (MCU), a hardware accelerator, a special-purpose computer chip, or the like.

The computing device 600 may further comprise a memory 602. The memory 602 may be configured to store, for example, computer programs and the like. The memory 602 may comprise one or more volatile memory devices, one or more non-volatile memory devices, and/or a combination of one or more volatile memory devices and non-volatile memory devices. For example, the memory 602 may be embodied as magnetic storage devices (such as hard disk drives, magnetic tapes, etc.), optical magnetic storage devices, and semiconductor memories (such as mask ROM, PROM (programmable ROM), EPROM (erasable PROM), flash ROM, RAM (random access memory), etc.).

The computing device 600 may further comprise other components not illustrated in the embodiment of FIG. 6. The computing device 600 may comprise, for example, an input/output bus for connecting the computing device 600 to other devices.

When the computing device 600 is configured to implement some functionality, some component and/or components of the computing device 600, such as the at least one processor 601 and/or the memory 602, may be configured to implement this functionality. Furthermore, when the at least one processor 601 is configured to implement some functionality, this functionality may be implemented using program code comprised, for example, in the memory.

The computing device 600 may be implemented at least partially using, for example, a computer, some other computing device, or similar.

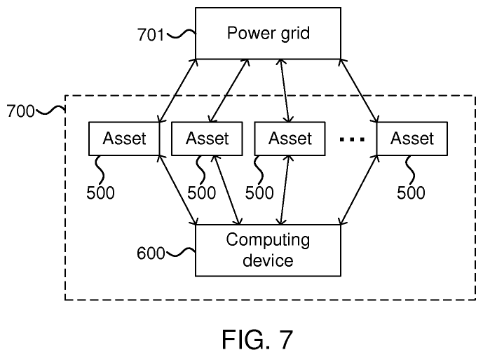

FIG. 7 illustrates a schematic representation of a virtual power plant according to an embodiment.

According to an embodiment, a virtual power plant 700 comprises the computing device 600 a plurality of assets 500 coupled to a power grid 701, wherein each asset in the plurality of assets 500 comprises at least one battery unit.

The virtual power plant 700 may also be referred to as a virtual power plant system, a distributed energy storage system, Or similar.

Each asset in the plurality of assets 500 may be coupled to the computing device 600. Thus, the computing device 600 may be configured to control each asset 500 in the plurality of assets according to the method 100.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method for managing a plurality of assets of a virtual power plant, wherein each asset in the plurality of assets comprises at least one battery unit, the method comprising:
assigning the plurality of assets into a plurality of groups, wherein the plurality of groups comprises at least a reserve group and at least one active group and each asset in the plurality of assets is assigned to one group in the plurality of groups, where-in the assigning the plurality of assets into the plurality of groups comprises assigning the plurality of assets into the plurality of groups for each time slot in a plurality of power grid market times slots;
in response to receiving an activation signal for power grid frequency balancing, offering as-sets for the power grid frequency balancing from groups in the plurality of groups other than the reserve group by offering assets for the power grid frequency balancing from the at least one active group; and
in response to detecting a need for state of charge adjustment in the virtual power plant, performing the state of charge adjustment using the reserve group.

2. The computer-implemented method according to claim 1, the method further comprising, in response to detecting a need for reassigning at least one asset in the plurality of assets, reassigning the at least one asset into the plurality of groups.

3. The computer-implemented method according to claim 2, wherein the need for reassigning the at least one asset in the plurality of assets corresponds a change in a power grid market time slot.

4. The computer-implemented method according to claim 2, wherein the need for reassigning the at least one asset in the plurality of assets comprises needing to reassign at least one problematic asset in the at least one active group and the reassigning the at least one asset in the plurality of assets into the plurality of groups comprises reassign the at least one problematic asset to the reserve group.

5. The computer-implemented method according to claim 4, wherein the needing to reassign the at least one problematic asset in the at least one active group comprises an operating parameter of the at least one problematic asset in the at least one active group being outside a preconfigured operating parameter range.

6. The computer-implemented method according to claim 5, wherein the operating parameter comprises a state of charge, an operating temperature and/or a battery state of health.

7. The computer-implemented method according to claim 4, wherein the reassigning the at least one asset in the plurality of assets into the plurality of groups further comprises assigning at least one replacement asset for the at least one problematic asset from the reserve group to the at least one active group.

8. (canceled)

9. The computer-implemented method according to any claim 1, wherein the assigning the plurality of assets into the plurality of groups comprises assigning the plurality of assets into the plurality of groups based at least on a likelihood of each asset in the plurality of assets needing state of charge adjustment during a time period when the plurality of assets is used for the power grid frequency balancing.

10. The computer-implemented method according to any claim 1, wherein the assigning the plurality of assets into the plurality of groups further comprises:
determining a required state of charge adjustment capacity for the virtual power plant; and
assigning the plurality of assets into the plurality of groups based at least on the required state of charge adjustment capacity.

11. The computer-implemented method according to any claim 1, wherein the at least one active group comprises a plurality of active groups and each active group in the plurality of active groups corresponds to a use case in a plurality of use cases.

12. A computing device, comprising at least one processor and at least one memory including computer program code, the at least one memory and the computer program code configured to, with the at least one processor, cause the computing device to perform the method according to claim 1.

13. A virtual power plant comprising the computing device according to claim 12 and a plurality of assets coupled to a power grid, wherein each asset in the plurality of assets comprises at least one battery unit.

14. A computer program product comprising program code configured to perform the method according to claim 1 when the computer program product is executed on a computer.
